(19) United States
(12) Patent Application Publication
(10) Pub. No.: US 2012/0132454 A1
(43) Pub. Date: May 31, 2012

(54) ELECTRICAL JUNCTION BOX

(75) Inventors: Takashi Miyamoto, Yokkaichi-city (JP); Takamasa Kubota, Yokkaichi-city (JP)

(73) Assignee: SUMITOMO WIRING SYSTEMS, LTD., Mie (JP)

(21) Appl. No.: 13/205,125

(22) Filed: Aug. 8, 2011

(30) Foreign Application Priority Data
Nov. 26, 2010 (JP) 2010-263624

(51) Int. Cl. H02G 3/08

(52) U.S. Cl. 174/50

(57) ABSTRACT

An object of the present invention is to provide an electrical junction box having a new structure that is formed by using a plurality of bushes in the same mold in correspondence with different kinds of casing body and can be readily and rapidly recognized whether or not the electrical junction box is formed by the regular bushes. Casing bodies are provided with common molding portions that are formed by the same mold, and a plurality of bush molding portions that are formed by exchangeable bushes with the same mold in correspondence with kinds of box bodies. Common identification marks corresponding to the kinds of box bodies are formed on the bush molding portions by the bushes.

### CROSS-REFERENCE TO RELATED APPLICATIONS

The present application claims priority under 35 U.S.C. §119 of Japanese Application No. 2010-263624, filed on Nov. 26, 2010, which is herein expressly incorporated by reference in its entirety.

### TECHNICAL FIELD

This invention relates to an electrical junction box that includes a casing body made of a synthetic resin by a mold, and more particularly relates to an electrical junction box that includes a bush molding portion formed by the bush of the mold.

### BACKGROUND ART

Heretofore, an electrical junction box has been used in a motor vehicle or the like in order to efficiently arrange electrical wires. Such electrical junction box includes a casing body such as an upper casing, a lower casing, a support member for a current-carrying element that are formed by injecting a synthetic resin into a mold. The current-carrying element is arranged in the casing body.

In the motor vehicle or the like, there are many cases that attaching portions or similar portions to be coupled to a vehicle body panel are slightly different on account of a vehicle type, a vehicle grade, or the like, although a main part of the casing body has the same structure.

In these cases, it will increase cost in production to prepare a mold for every a kind of casing box having slightly different parts. Therefore, heretofore, as disclosed in, for example, JP HEI 11 (1999)-27827 A, the same mold is used to form the main part of the casing body while a bush to be inserted into the same mold is used to form a different part such as an attaching portion for attaching to the vehicle body panel. The prior art casing body can deal with differences of the vehicle type or the vehicle grade by exchanging the bush in correspondence with the kind of casing box.

However, a single casing body includes a plurality of bush molding portions such as the attaching portions to be coupled to the vehicle body, which are formed into changeable shapes by the bushes. Accordingly, it is necessary to set regular bushes on all of the plural positions on the single mold in correspondence with the kind of casing body. However, it is difficult to visually recognize whether or not all of the bush molding portions are formed by the regular bushes. In fact, there are some cases that the above recognition is impossible before the casing body is incorporated with the vehicle body. This will lower efficiency in production.

### DISCLOSURE OF THE INVENTION

### Problems that the Invention is to Solve

In view of the above problems, an object of the present invention is to provide an electrical junction box having a new structure that is formed by using a plurality of bushes in the same mold in correspondence with different kinds of casing body and can be readily and rapidly recognized whether or not the electrical junction box is formed by the regular bushes.

### Means for Solving the Problems

A first aspect of the present invention is directed to an electrical junction box including a casing body made of a synthetic resin. The casing body includes a common molding portion that is formed by the same mold, and a plurality of bush molding portions that are formed by exchangeable bushes with the same mold in correspondence with different kinds of casing body. A common identification mark corresponding to different kinds of casing body is formed on the bush molding portions by the bushes.

According to the electrical junction box in the first aspect of the present invention, if all the bush molding portions are formed by the regular bushes, the common identification mark is formed on each of the bush molding portions of the casing body. Accordingly, it is possible for a visual check to easily and rapidly recognize whether or not all the bush molding portions are formed by the regular bushes in correspondence with the different kinds of casing body, on the basis of whether or not the common identification mark is formed on all the bush molding portions.

Since the identification mark is formed by the bush, the bush is provided on its molding surface with the identification mark. Thus, it is possible to facilitate a control of bushes by confirming the identification mark on each bush. For example, it is possible to readily confirm whether or not the bush set in the mold is regular.

The identification mark can be any suitable mark or indicia, such as a pattern “◯” (circle) or a pattern “□” (square), or a character. The common identification mark corresponding to the different kinds of casing body can adopt not only the same identification mark for the same kind, such as a pattern “◯” (one circle) for a kind A and patterns “◯ ◯” (two circles) for a kind B, or a pattern “◯” (one circle) for a kind A and a pattern “□” (square) for a kind B, but also signs belonging to the same category for the same kind, such as an Arabic figure for a kind A and a Roman figure for a kind B, so that different categories express different kinds. Thus, for example, the Arabic figures “1”, “2”, “3”, . . . are given to a kind A of bushes, the Roman figures “I”, “II”, “III”, . . . are given to a kind B of bushes. Consequently, it is possible to define the positions for the bushes in the mold while distinguishing between the kind A of bushes and the kind B of bushes.

In addition, it is possible to adopt the common identification mark corresponding to the kind in part. For example, a kind A may be expressed by signs “A−1”, “A−2”, “A−3” . . . using a sign “A” as the common identification mark and a kind B may be expressed by signs “B−1”, “B−2”, “B−3” . . . using a sign “B” as the common identification mark. Furthermore, the identification mark may include a plain, unmarked condition in connection with other kind of casing body. That is, an identification mark for the kind A is a plain condition while an identification mark for the kind B is a visual pattern. If all the bush molding portions are plain, it may be possible to recognize that the bush molding portions are formed by regular bushes of the kind A.

The casing body made of a synthetic resin includes all resin molding portions in the electrical junction box, such as upper casing, a lower casing, or a casing body in which current-carrying elements are mounted. The bush molding portion is not limited so long as it is a portion formed by the bush. The bush molding portion may be an attaching portion to be coupled to a vehicle body panel, which is different on account of a vehicle type in many cases or a coupling portion between an upper casing and a lower casing, which is different on account of a vehicle type, if a casing body includes the upper and lower casings.

A second aspect of the present invention is directed to the electrical junction box according to the first aspect. In the electrical junction box in the second aspect, the identification mark is formed on the same directional surface on each of the bush molding portions.

According to the electrical junction box in the second aspect of the present invention, it is possible to recognize the identification marks of all the bush molding portions by viewing the casing body from only one side. Thus, it is possible to easily and rapidly recognize the identification marks of all the bush molding portions without turning the casing body.

### Effects of the Invention

According to the present invention, the common identification mark corresponding to the kind of casing body is formed on the plural bush molding portions formed by the bushes. Thus, it is possible to readily and rapidly recognize whether or not all the bush molding portions are formed by regular bushes by confirming whether or not the common identification mark is formed on all the bush molding portions. It is possible to facilitate a control of the bush by the identification mark for the bush.

### BRIEF EXPLANATION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a plan view of a first embodiment of an upper casing that constitutes a part of an electrical junction box of the present invention.

FIG. 2 is a plan view of another kind of upper casing different from the upper casing shown in FIG. 1.

FIG. 3 is side elevation views of the upper casing shown in FIG. 1 and a lower casing corresponding to the upper casing.

FIG. 4 is a side elevation view of the upper and lower casings shown in FIG. 3, illustrating the casings incorporated with each other.

FIG. 5 is a plan view of a second embodiment of an upper casing that constitutes a part of an electrical junction box of the present invention.

### PREFERRED ASPECTS OF EMBODYING THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

Referring now to the drawings, embodiments of an electrical junction box in accordance with the present invention will be described below.

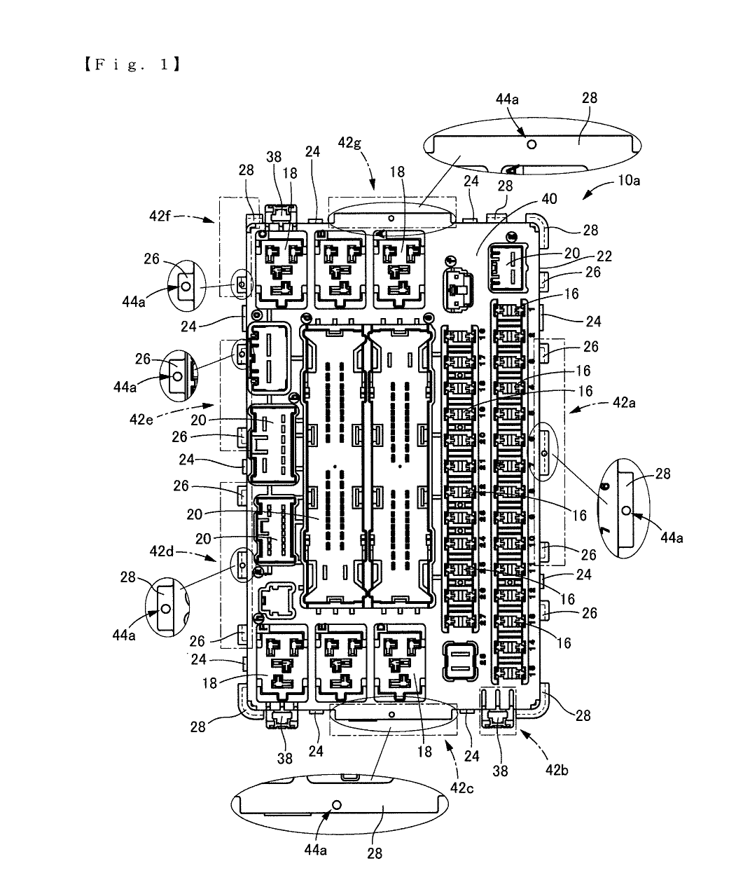

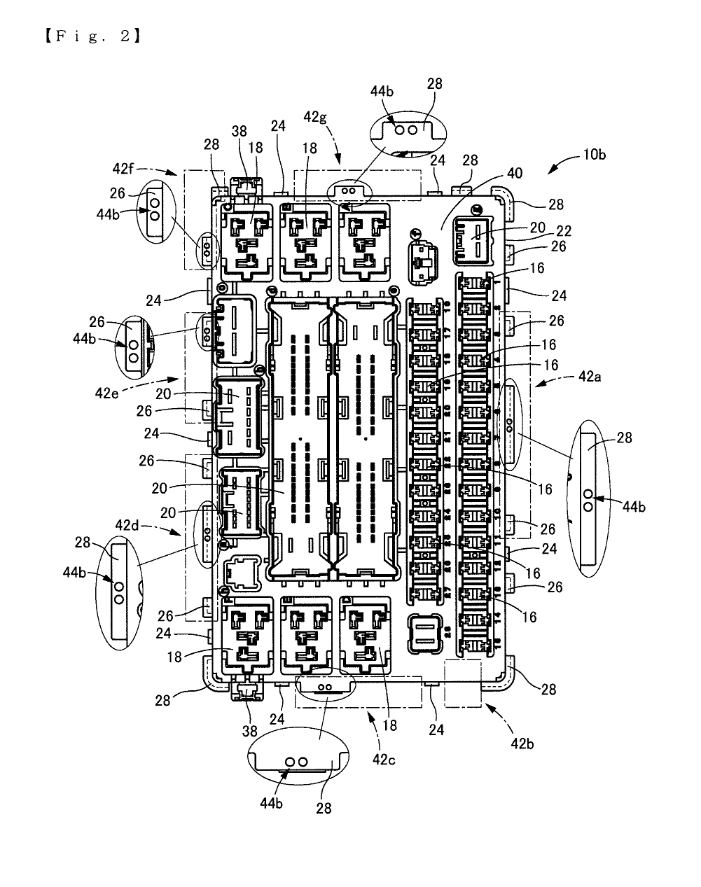

FIGS. 1 and 2 show an upper casing 10a and an upper casing 10b that constitute an electrical junction box in accordance with the present invention. The upper casings 10a and 10b are made of a synthetic resin, or other suitable material, and are formed into casing bodies, respectively.

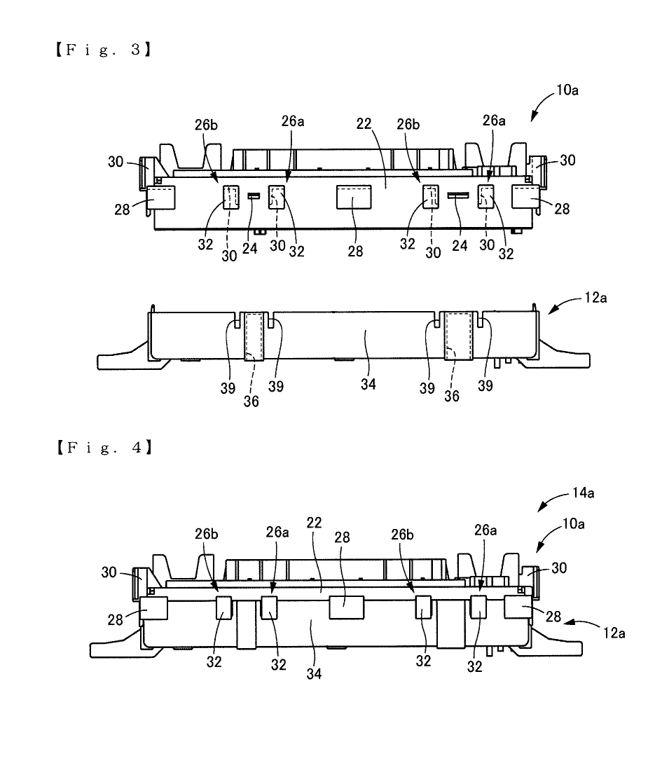

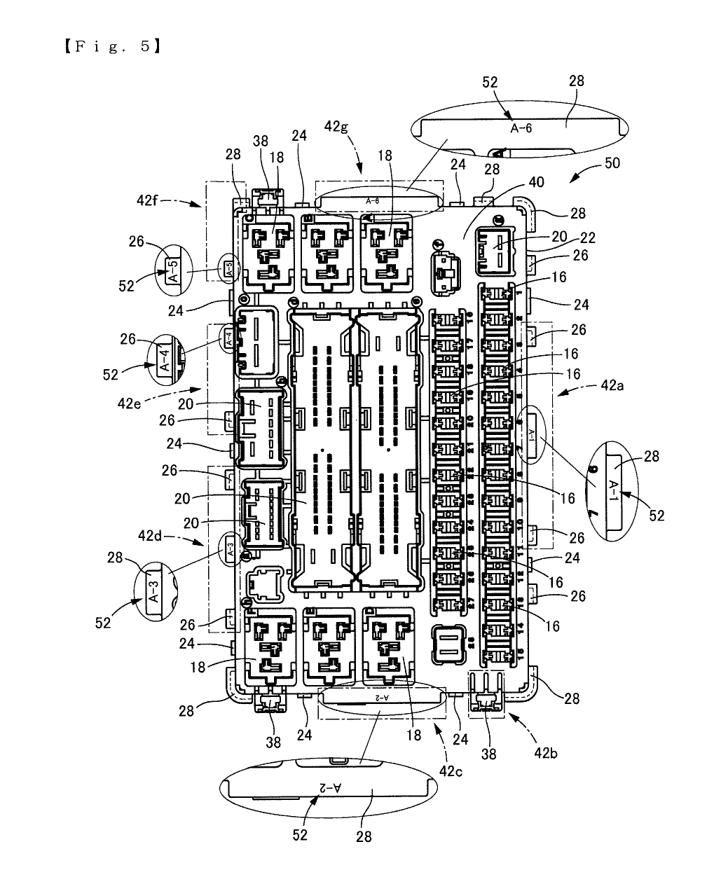

As shown in FIG. 3, the upper casing 10a is incorporated with a lower casing 12a to form a casing body. Thus, as shown in FIG. 4, the upper and lower casings 10a and 12a constitute an electrical junction box 14a to be mounted on a motor vehicle or the like. The upper casing 10b (FIG. 2) is incorporated with a lower casing (not shown) corresponding to the upper casing 10b to constitute an electrical junction box, as is the case with the upper casing 10a.

The upper casing 10a is formed into a box-like configuration that is open at the side of the lower casing 12a. The upper casing 10a is provided with a plurality of fuse-mounting sections 16, a plurality of relay-mounting sections 18, and a plurality of connector-mounting sections 20. These sections 16, 18, and 20 serve as electrical component-mounting sections.

Furthermore, the upper casing 10a is provided on its peripheral wall 22 with latching pawls 24, fitting portions 26, pinching portions 28, and the like so that the latching pawls 24 and portions 24, 26, 28 serve to incorporate the upper casing 10a with the lower casing 12a. Each latching pawl 24 protrudes outward from the peripheral wall 22 to form a projection. A pair of fitting portions 26, 26 are provided on both sides of each latching pawl 24. Each fitting portion 26 is open at the side of the lower casing 12a. The fitting portion 26 includes a projection rib 30 that protrudes outward from the peripheral wall 22, and a plate portion 32 coupled to a projection end edge of the projection rib 30. Each projection rib 30 is formed into a substantially L-shape in cross section in which an end at the side of the latching pawl 24 extends toward the lower casing 12a (in a lower direction in FIG. 3).

The peripheral wall 22 is provided on suitable positions on its peripheral surface with pinching portions 28. Each pinching portion 28 is formed into a substantially L-shape in cross section that extends in a peripheral direction of the peripheral wall 22 and is open at the side of the lower casing 12a. In particular, the upper casing 10a is provided around its three corners with the pinching portions 28. Furthermore, the upper casing 10a is provided on suitable positions on its outer peripheral surface with attaching portions 38 for receiving other members.

A peripheral wall 34 of the lower casing 12a is mounted on the outside of the peripheral wall 22 of the upper casing 10a. Thus, the latching pawls 24 of the upper casing 10a are engaged with latching recesses 36 provided on an inner surface of the lower casing 12a. At the same time, the projection ribs 30, 30 on the fitting portions 26a, 26b of the upper casing 10a are inserted into slits 39 in the peripheral wall 34 of the lower casing 12a, so that the peripheral wall 34 of the lower casing 12a is pinched between the peripheral wall 22 and the plate portions 32. Furthermore, the peripheral wall 34 of the lower casing 12a is pinched between the peripheral wall 22 of the upper casing 10a and the pinching portions 28. Thus, the upper and lower casings 10a and 12a are interconnected to form the electrical junction box 14a.

On the other hand, the upper casing 10b shown in FIG. 2 is used for a vehicle type different from that of the upper casing 10a. The upper casing 10b includes fuse-mounting sections 16, relay-mounting sections 18, and connector-mounting sections 20. These sections 16, 18, 20 have the same configurations as those of the upper casing 10a. However, the upper casing 10b includes fitting portions 26, pinching portions 28, and attaching portions 38 that have different configurations from those of the upper casing 10a in part.

That is, the upper casings 10a and 10b are produced by a resin molding process (for example, an injection molding process) that uses a mold. The resin molding process has been known in the prior art. The same fuse-mounting sections 16, same relay-mounting sections 18, and same connector-mounting sections 20, and the same fitting portions 26, same pinching portions 28, and same attaching portions in part in the upper casings 10a and 10b are molded as common molding portions 40 by the same mold. On the other hand, the different fitting portions 26, different pinching portions 28, and different attaching portions 38 of the upper casings 10a and 10b in part are molded to be bush molding portions 42a to 42g by bushes that are interchangeably incorporated with the same mold that produces the common molding portions 40 in association with the upper casings 10a and 10b.

In the first embodiment, bush molding portions 42a, 42c, 42d, and 42g in the upper casing 10a and 10b are provided with the pinching portions 28. A size of each pinching portion 28 (a dimension in length in the peripheral direction of the peripheral wall 22) in the upper casing 10a is different from that in the upper casing 10b. The bush molding portion 42b in the upper casing 10a is provided with the attaching portion 38. On the contrary, the bush molding portion 42b in the upper casing 10b is not provided with the attaching portion 38. Furthermore, the bush molding portions 42e and 42f are provided with the fitting portions 26. Sizes of the fitting portions 26 (dimensions in length in the peripheral direction of the peripheral wall 22) in the upper casing 10a are different from those in the upper casing 10b.

Identification marks or indicia 44 are provided on the pinching portions 28 and fitting portions 26 formed on the bush molding portions 42 (42a to 42g). The identification marks may be any suitable indicia or signs, such as characters or patterns. Discriminable signs can be adopted in the upper casings 10a and 10b. In the first embodiment, the identification mark 44a adopts a single sign “◯” (one circle) in the upper casing 10a while the identification mark 44b adopts two signs “◯ ◯” (two circles) in the upper casing 10b. All the identifications 44a and 44b are provided on upper sides (upper sides in FIG. 3) of the pinching portions 28 and fitting portions 26 in the upper casings 10a and 10b. Hereinafter, if it is not necessary to discriminate the identification marks 44a and 44b, they are described as the identification marks 44. The identification marks are provided on the attaching portions 38, as a matter of course.

Such identification marks 44 are formed on the pinching portions 28 and fitting portions 26 by bushes that form the bush molding portions 42. That is, a single sign “◯” (one circle) is formed on a molding surface on each bush that forms each bush molding portion 42 of the upper casing 10a. Two signs “◯ ◯” (two circles) are formed on the molding surface on each bush that forms each bush molding portion 42 of the upper casing 10b. These bushes are incorporated with the mold that forms the common molding portion 40. When a molten resin material is injected into and solidified in the mold, the signs “◯” (one circle) formed on the molding surfaces of the bushes are transferred to the pinching portions 28 and fitting portions 26.

According to the present invention, if the bush molding portions 42a to 42g are formed by regular bushes, the identification marks 44a are formed on the pinching portions 28 and fitting portions 26 on the bush molding portions 42a to 42g in the upper casing 10a while the identification marks 44b are formed on the pinching portions 28 and fitting portions 26 on the bush molding portions 42a to 42g in the upper casing 10b. Thus, it is possible to determine whether or not the upper casing 10a or 10b is formed by the regular bushes on the basis of whether or not the same identification marks 44a or 44b are formed on the pinching portions 28 and fitting portions 26a, 26b on all the bush molding portions 42a to 42g. Consequently, it is possible to rapidly and readily find defective upper casings 10a or 10b, before the defective upper casings 10a or 10b are incorporated with the lower casing 12a or 12b, or before other members are attached to the attaching portions 38. In the first embodiment, a plurality of identification marks 44a and 44b to be formed on the upper casings 10a and 10b are formed on the top surfaces of the pinching portions 28 and fitting portions 26. Thus, it is possible to readily confirm all the identification marks 44a and 44b merely by visual observation from the upper side (upper side in FIG. 3) without requiring an operation of turning the upper casings 10a and 10b.

Furthermore, since the identification marks 44 are formed by the bushes, the identification marks 44 are formed on the molding surfaces on the bushes. Thus, it is possible to easily recognize whether or not the regular bushes are set in the mold that forms the common molding portions 40 in correspondence with the upper casing 10a or 10b by confirming the identification marks 44 formed on the bushes. Particularly, in the first embodiment, since the identification marks 44a and 44b are formed by the sing “◯” (circle) that is rotational symmetry, it is possible to confirm the identification marks 44a and 44b without reversing the identification marks on the molding surfaces that are asymmetrical in right and left.

Although the first embodiment of the present invention is described above in detail, it should be noted that the present invention is not limited to the specific descriptions. As described above, it is possible to select any kinds of signs or indicia such as characters, or patterns as the identification marks. For example, FIG. 5 shows a second embodiment different from the first embodiment. In the second embodiment, an upper casing 50 is provided as a casing body different from that in the first embodiment. The upper casing 50 has the substantially same structure as that of the upper casing 10a. An explanation about the parts in the upper casing 50 that are the same as those in the upper casing 10 is omitted here merely by giving the same signs to the same parts.

Each identification mark or indicia 52 in the upper casing 50 comprises a combination of a character of an alphabet “A-” and Arabic figures. The Arabic figures “1” to “6” are given to the respective bush molding portions 42a to 42g (except 42b). If the upper casing 50 is a different kind of upper casing that have different shapes of the upper casing 50 and the bush molding portions 42a to 42g, although they are not shown in FIG. 5, a kind of upper casing 50 can be discriminated by setting characters of the alphabet “B-”, “C-” for the character of the alphabet “A-” on the identification mark 52. Thus, it is possible to adopt the characters as the identification marks and it is possible to set a part of the identification marks to be different in accordance with a kind of casing body. According to the second embodiment, it is possible to easily recognize a setting position of a bush on the mold upon molding the upper casing 50 by giving the numerals to the respective bush molding portions 42a to 42g.

Furthermore, the identification marks may be plain or unmarked. That is, if any signs are not displayed on all the bush molding portions in connection with the identification signs on other kind of casing body by applying visual signs to the other kind of casing body, it is possible to recognize that a regular bush is incorporated with a casing body in question.

In the first and second embodiments, although locking portions between the lower casing and the fitting portions 26 and pinching portions 28 are set to be the bush molding portions, it should be noted that the bush molding portions are not limited, and could be any suitable portion. For example, if the number of fuses to be mounted on the fuse-mounting sections is different on account of a kind of casing body, the fuse-mounting section may be set to be the bush molding portion and the identification mark may be provided on a suitable position on the fuse-mounting section.

Furthermore, the present invention can be commonly applied to constituent members made of a resin for the electrical junction box. For example, it is possible to apply the present invention to the lower casing together with the upper casing, as a matter of course. In this case, it is preferable to recognize a relationship between the upper casing and the lower casing by utilizing the common identification mark for the upper and lower casings.

### EXPLANATION OF SIGNS

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An electrical junction box including a casing body made of a synthetic resin, said casing body comprising:
a common molding portion that is formed by a common mold;
a plurality of bush molding portions that are formed by bushes, said bushes being exchangeably connected with said common mold in correspondence with different kinds of casing body; and
an identification mark that is formed on said bush molding portions by said bushes, said identification mark corresponding to different kinds of casing body.

2. An electrical junction box according to claim 1, wherein said identification mark is formed on the same directional surface on each of the bush molding portions.
